(19) United States
(12) Patent Application Publication
(10) Pub. No.: US 2014/0074949 A1
(43) Pub. Date: Mar. 13, 2014

(54) BLOG MIGRATION MANAGEMENT

(71) Applicant: Hyun-Oh Oh, Gwachon-si (KR)

(72) Inventor: Hyun-Oh Oh, Gwachon-si (KR)

(73) Assignee: EMPIRE TECHNOLOGY DEVELOPMENT LLC, Wilmington, DE (US)

(21) Appl. No.: 13/996,273

(22) PCT Filed: Sep. 11, 2012
(86) PCT No.: PCT/US12/54613

§ 371 Date: Jun. 20, 2013

(51) Int. Cl. H04L 29/08

(52) U.S. Cl. CPC H04L 67/02
USPC 709/206; 709/204

(57) ABSTRACT

Technologies are generally described for a blog migration management scheme. In some examples, a blog migration management system may include a blog content extraction unit configured to extract blog content posted on a source blog, a user identification unit configured to identify from the source blog an identification of a user who posted the blog content, and a blog content loading unit configured to load the blog content onto a destination blog, with granting the user an authority for the blog content on the destination blog.

### BACKGROUND

A blog is a web site that consists of a series of discrete posts typically arranged in reverse chronological order, often updated with new information about particular subjects. Typically, a blog owner or author writes blog posts on the blog, and allow visitors to leave comments to the owner's posts and/or write their own posts. There are lots of blog service providers, each providing unique blog formats and/or tools.

### SUMMARY

In an example, a blog migration management system may include a blog content extraction unit configured to extract blog content posted on a source blog; a user identification unit configured to identify from the source blog an identification of a user who posted the blog content; and a blog content loading unit configured to load the blog content onto a destination blog, with granting the user an authority for the blog content on the destination blog.

In another example, a method performed under control of a blog migration management system may include extracting blog content posted on a source blog; identifying from the source blog a first identification for the source blog, a user of which posted the blog content on the source blog; determining whether an identification mapping database has stored thereon a pair of the first identification for the source blog and a second identification for a destination blog associated with the first identification; and loading the extracted blog content onto the destination blog with granting the second identification an authority for the blog content on the destination blog, when the identification mapping database has stored thereon the pair of the first identification for the source blog and the second identification for the destination blog.

In yet another example, a computer-readable storage medium may store thereon computer-executable instructions that, in response to execution, cause a blog migration management system to perform operations, including migrating blog content posted on a source blog to a destination blog; identifying from the source blog a first identification for the source blog, a user of which posted the blog content on the source blog; retrieving from an identification mapping database a second identification for the destination blog associated with the first identification for the source blog; and granting the second identification an authority for the blog content migrated to the destination blog.

The foregoing summary is illustrative only and is not intended to be in any way limiting. In addition to the illustrative aspects, embodiments, and features described above, further aspects, embodiments, and features will become apparent by reference to the drawings and the following detailed description.

### BRIEF DESCRIPTION OF THE FIGURES

The foregoing and other features of this disclosure will become more apparent from the following description and appended claims, taken in conjunction with the accompanying drawings. Understanding that these drawings depict only several embodiments in accordance with the disclosure and are, therefore, not to be considered limiting of its scope, the disclosure will be described with additional specificity and detail through use of the accompanying drawings, in which:

FIG. 1 schematically shows an illustrative example of blog migration from a source blog to a destination blog, arranged in accordance with at least some embodiments described herein;

FIG. 2 schematically shows an illustrative example of an environment in which a blog migration management system manages blog migration from a source blog to a destination blog, arranged in accordance with at least some embodiments described herein;

FIG. 3 schematically shows an illustrative example of an identification mapping database for providing a blog migration management scheme, arranged in accordance with at least some embodiments described herein;

FIG. 4 shows a schematic block diagram illustrating an example architecture of a blog migration management system, arranged in accordance with at least some embodiments described herein;

FIG. 5 shows an example flow diagram of a process for providing a blog migration management scheme, arranged in accordance with at least some embodiments described herein;

FIG. 6 illustrates example computer program products that may be utilized to provide a blog migration management scheme, arranged in accordance with at least some embodiments described herein; and

FIG. 7 is a block diagram illustrating an example computing device that may be utilized to provide a blog migration management scheme, arranged in accordance with at least some embodiments described herein.

### DETAILED DESCRIPTION

In the following detailed description, reference is made to the accompanying drawings, which form a part hereof. In the drawings, similar symbols typically identify similar components, unless context dictates otherwise. The illustrative embodiments described in the detailed description, drawings, and claims are not meant to be limiting. Other embodiments may be utilized, and other changes may be made, without departing from the spirit or scope of the subject matter presented herein. It will be readily understood that the aspects of the present disclosure, as generally described herein, and illustrated in the drawings, can be arranged, substituted, combined, separated, and designed in a wide variety of different configurations, all of which are explicitly contemplated herein.

This disclosure is generally drawn, inter alia, to methods, apparatuses, systems, devices, and computer program products related to a blog migration management scheme. Further, technologies are herein generally described for managing migration of blog contents posted on a source blog, including those by users other than a blog owner, to a destination blog.

In some embodiments, when a blog owner decides to stop using his/her existing blog (i.e., a source blog) and move previously posted blog contents to a new blog (i.e., a destination blog), a blog migration management system may extract the blog contents from the source blog and load the extracted blog contents onto the destination blog, that is, migrate the blog contents from the source blog to the destination blog. The blog migration management system may be operated or controlled by a service provider of the destination blog or by a third party providing a blog migration service. By way of example, but not limitation, the blog contents may include blog posts, comments to the blog posts, image files, video files, audio files, and any contents that may be posted on the source blog.

The blog migration management system may allow the blog owner to edit and/or delete the blog contents that are originally posted by the blog owner on the source blog and then migrated to the destination blog. The blog migration management system may also allow a guest user, i.e., not the blog owner, to edit and/or delete at least some of the blog contents that are originally posted by the guest user on the source blog and then migrated to the destination blog, after the guest user has been authenticated based at least in part on an identification mapping database that is configured to store relationships between user identifications subscribed for the source blog and user identifications subscribed for the destination blog.

The blog migration management system may identify, from the source blog, a first identification of the guest user for the source blog. Then, the blog migration management system may determine whether the guest user has also subscribed to the destination blog by examining whether the identification mapping database has stored thereon a pair of the first identification and a second identification of the guest user for the destination blog.

When the identification mapping database stores the pair of the first identification and the second identification for the guest user, the blog migration management system may grant the guest user, who has the second identification, an authority for the blog contents migrated to the destination blog. In such cases, the guest user may edit and/or delete the blog contents migrated to the destination blog.

When the identification mapping database does not store the pair of the first identification and the second identification of the guest user, the blog migration management system may issue an invitation for the guest user to subscribe to the destination blog and/or the identification mapping database. Then, the blog migration management system may send the invitation to the guest user via a communication means registered by the guest user for the source blog, including at least one of an electronic mail (e-mail) message, a short message service (SMS) message, a social network service (SNS) message, and a voice message.

Upon receiving the invitation, the guest user may respond to the invitation. When the guest user has already subscribed for the destination blog, but the identification mapping database does not store the guest user's second identification for the destination blog, the guest user may send his/her second identification for the destination blog to the blog migration management system, in response to the invitation. In such cases, the blog migration management system may update the identification mapping database to have further stored thereon a pair of the first identification and the received second identification. Meanwhile, when the guest user has not subscribed for the destination blog, the guest user may send a request for subscribing to the destination blog and the identification mapping database, in response to the invitation. In such cases, the blog migration management system may update the identification mapping database to have further stored thereon a pair of the first identification and the second identification created in accordance with the request.

When the guest user does not respond to the invitation, or when there is no communication means registered by the guest user for the source blog, the blog migration management system may render the blog contents of the guest user incapable of being edited on the destination blog. That is, the guest user may not edit and/or delete the blog contents migrated to the destination blog. However, the blog migration management system may provide the guest user with the authority for the blog contents migrated to the destination blog, once the guest user authorizes the blog contents, by using, for example, his/her identification and password which he/she used at the time of posting the blog contents on the source blog.

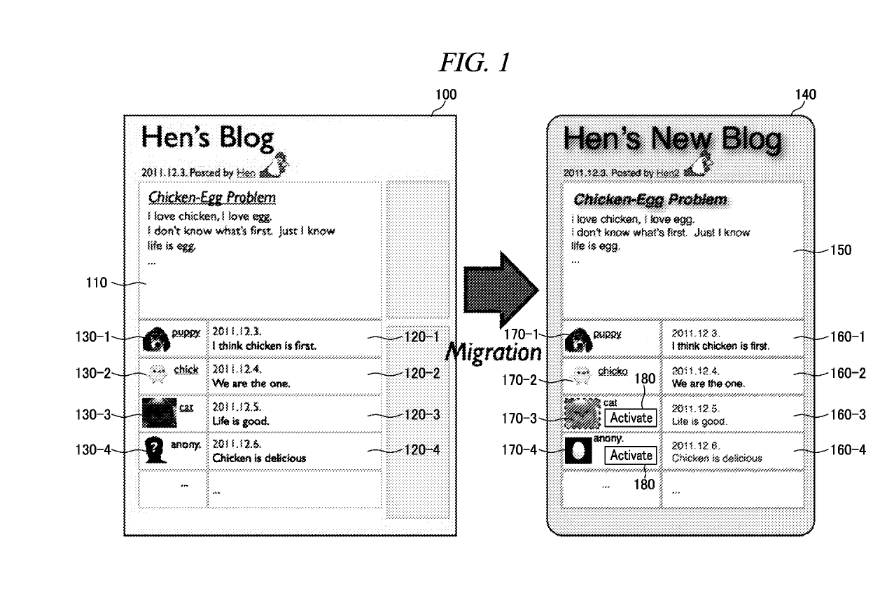

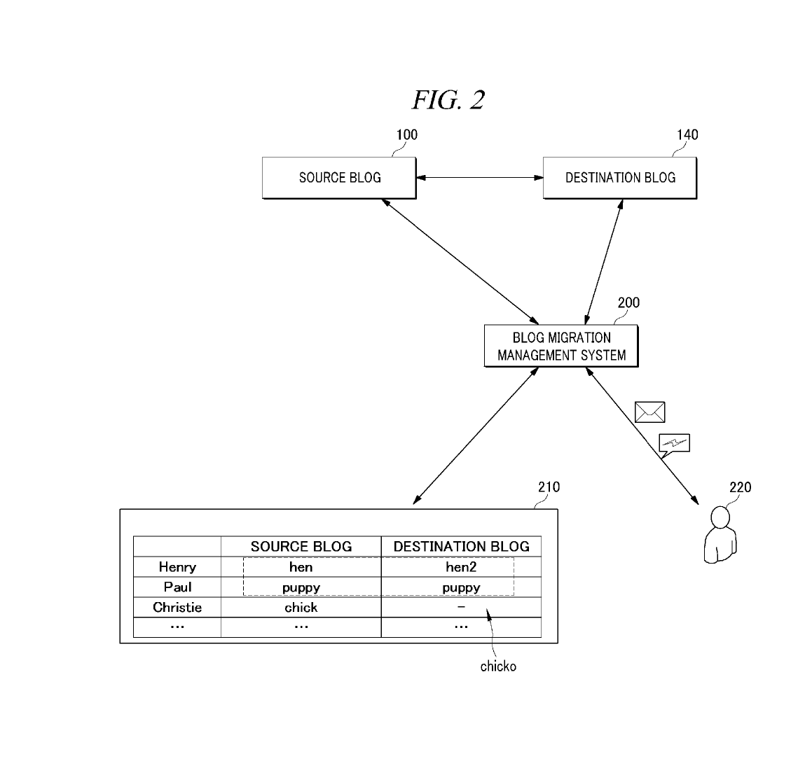

FIG. 1 schematically shows an illustrative example of blog migration from a source blog to a destination blog, arranged in accordance with at least some embodiments described herein; and FIG. 2 schematically shows an illustrative example of an environment in which a blog migration management system manages blog migration from a source blog to a destination blog, arranged in accordance with at least some embodiments described herein.

As depicted in FIG. 1, a blog owner, “Henry,” may have run or operated a source blog 100, with an identification “Hen.” The blog owner may post a blog post 110 on source blog 100, and users other than the blog owner may write comments 120-1, 120-2, 120-3 and 120-4 to blog post 110. In some embodiments, source blog 100 may show who has written comments 120-1, 120-2, 120-3 and 120-4. In some embodiments, when the users who wrote comments 120-1, 120-2, 120-3 have subscribed to source blog 100, source blog 100 may show comments 120-1, 120-2 and 120-3 with identifications “puppy” 130-1, “chick” 130-2 and “cat” 130-3 corresponding to the respective users who posted the comments. In some embodiments, when the user who wrote comment 120-4 is not identified to source blog 100, source blog 100 may show comment 120-4 with a predetermined “anonymous” symbol 130-4.

In some embodiments, when the blog owner requests migration of source blog 100 to a destination blog 140, a blog migration management system 200 as depicted in FIG. 2 may extract, from source blog 100, blog contents including blog post 110 and comments 120-1, 120-2, 120-3 and 120-4, and load the extracted blog contents onto destination blog 140. Then, destination blog 140 may show blog post 150 and comments 160-1, 160-2, 160-3 and 160-4, respectively corresponding to blog post 110 and comments 120-1, 120-2, 120-3 and 120-4 of source blog 100. In some embodiments, blog migration management system 200 may be operated or controlled by a service provider of destination blog 140, or by a third party providing a blog migration service.

In some embodiments, blog migration management system 200 may examine whether the users who wrote comments 120-1, 120-2, 120-3 have subscribed to destination blog 140. In some embodiments, blog migration management system 200 may refer to an identification mapping database 210 that is configured to store relationship between user identifications subscribed to source blog 100 and user identifications subscribed to destination blog 140. When one of the users subscribes to both source blog 100 and destination blog 140, identification mapping database 210 may store a pair of the corresponding user identifications for source blog 100 and for destination blog 140.

In some embodiments, identification mapping database 210 may be a component of blog migration management system 200. In some alternative embodiments, identification mapping database 210 may be separate from blog migration management system 200, but still be controlled by blog migration management system 200.

In some embodiments, when identification mapping database 210 stores a pair of identifications of one of the users, blog migration management system 200 may retrieve the corresponding user's identification for destination blog 140 from identification mapping database 210, and let destination blog 140 show the retrieved identification with that user's comments.

By way of example, but not limitation, it may be assumed that identification mapping database 210 pairs the identification “puppy” for source blog 100 and for destination blog 140 for the user “Paul,” as depicted in FIG. 2. In such case, blog migration management system 200 may let destination blog 140 show comment 160-1 corresponding to comment 120-1 written by “Paul” with identification “puppy” 170-1, and grant “Paul” authority to edit and/or delete comment 160-1.

In some embodiments, when identification mapping database 210 does not store a pair of identifications of one of the users, blog migration management system 200 may issue an invitation for a corresponding user 220 to subscribe to destination blog 140 and/or identification mapping database 210, and send the invitation to corresponding user 220 via a communication means registered for source blog 100. By way of example, but not limitation, the communication means may include an electronic mail (e-mail) message, a short message service (SMS) message, a social network service (SNS) message, and a voice message. Then, in some embodiments, based on a response from corresponding user 220, blog migration management system 200 may update identification mapping database 210.

By way of example, but not limitation, it may be assumed that the user identified as “chick” 130-2, i.e., “Christie,” has already subscribed to destination blog 140, but identification mapping database 210 does not pair the identifications for source blog 100 and destination blog 140. In such cases, blog migration management system 200 may send the invitation to “Christie.” When “Christie” sends his/her identification “chicko” for destination blog 140 to blog migration management system 200 in response to the invitation, blog migration management system 200 may update identification mapping database 210 to further pair the identification “chick” and the identification “chicko” for the user “Christie.” In such case, blog migration management system 200 may let destination blog 140 show comment 160-2 corresponding to comment 120-2 written by “Christie” with identification “chicko” 170-2, and grant “Christie” authority to edit and/or delete comment 160-2.

By way of another example, but not limitation, it may be assumed that the user of identification “chick” 130-2, i.e., “Christie,” has not subscribed for destination blog 140. In such cases, blog migration management system 200 may send the invitation to “Christie.” When “Christie” requests a subscription to destination blog 140 and identification mapping database 210 in response to the invitation, destination blog 140 may create a new identification “chicko” for “Christie,” and blog migration management system 200 may update identification mapping database 210 to further pair the identification “chick” 130-2 and the newly created identification “chicko.” Then, blog migration management system 200 may let destination blog 140 show comment 160-2 corresponding to comment 120-2 written by “Christie” with identification “chicko” 170-2, and grant “Christie” authority to edit and/or delete comment 160-2.

In some embodiments, when blog migration management system 200 does not receive a response to the invitation from one of the users, or does not know an appropriate communication means for contacting one of the users, blog migration management system 200 may render the corresponding comments incapable of being edited and/or deleted on destination blog 140, but provide an “Activate” button 180 with the corresponding comments so that the user may edit and/or delete the corresponding comments on destination blog 140 by using, for example, his/her identification and password for source blog 100. Alternatively, blog migration management system 200 may let the user edit or delete his/her comments on source blog 100, and modify the corresponding comments migrated to destination blog 140 accordingly.

By way of example, but not limitation, it may be assumed that blog migration management system 200 sent the invitation to the user of identification “cat” 130-3 but that user has not responded to the invitation, or blog migration management system 200 could not send the invitation to the user of identification “cat” 130-3. In such case, blog migration management system 200 may let destination blog 140 show comment 160-3 corresponding to comment 120-3 written by “cat” 130-3 with deactivated identification “cat” 170-3, and “Activate” button 180. When the user of identification “cat” 130-3 clicks “Activate” button 180, blog migration management system 200 may authenticate whether that user wrote comment 120-3 on source blog 100, by using his/her identification and password for source blog 100.

In some embodiments, for comment 120-4 written by an anonymous user, blog migration management system 200 may let destination blog 140 show comment 160-4 with an “anonymous” symbol 170-4 and “Activate” button 180, so that the anonymous user may edit and/or delete comment 160-4 by using, for example, his/her single-use identification and password which he/she used at the time of writing comment 120-4 on source blog 100. Alternatively, blog migration management system 200 may let the anonymous user edit and/or delete comment 120-4 on source blog 100, and modify comment 160-4 on destination blog 140 accordingly.

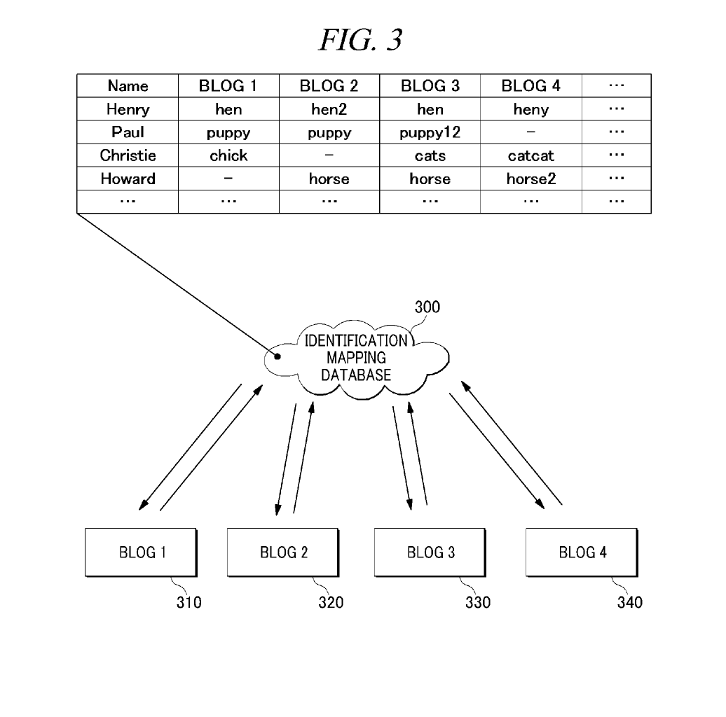

Although FIG. 2 illustrates that identification mapping database 210 stores the relationship between user identifications for two blogs (i.e., source blog 100 and destination blog 140), those skilled in the art will recognize that a blog migration service provider may operate an identification mapping database storing relationship between user identifications for three or more blogs, as illustrated in FIG. 3.

FIG. 3 schematically shows an illustrative example of an identification mapping database for providing a blog migration management scheme, arranged in accordance with at least some embodiments described herein.

As depicted, it may be assumed that multiple blogs including Blog 1 310, Blog 2 320, Blog 3 330 and Blog 4 340 subscribe for a blog migration service. In such case, a blog migration service provider may operate an identification mapping database 300 storing identifications of users for the multiple subscribed blogs.

By way of example, but not limitation, when a user “Henry” subscribes to Blog 1 310 with an identification “hen,” Blog 2 320 with an identification “hen2,” Blog 3 330 with an identification “hen,” and Blog 4 340 with an identification “heny,” identification mapping database 300 may store the four identifications for “Henry.” Similarly, when a user “Christie” subscribes to Blog 1 310 with an identification “chick,” Blog 3 330 with an identification “cats,” and Blog 4 340 with an identification “catcat,” identification mapping database 300 may store the three identifications for “Christie.” When “Christie” newly subscribes for Blog 2 320 with an identification “chicko,” identification mapping database 300 may be updated to further store the new identification “chicko” for “Christie.”

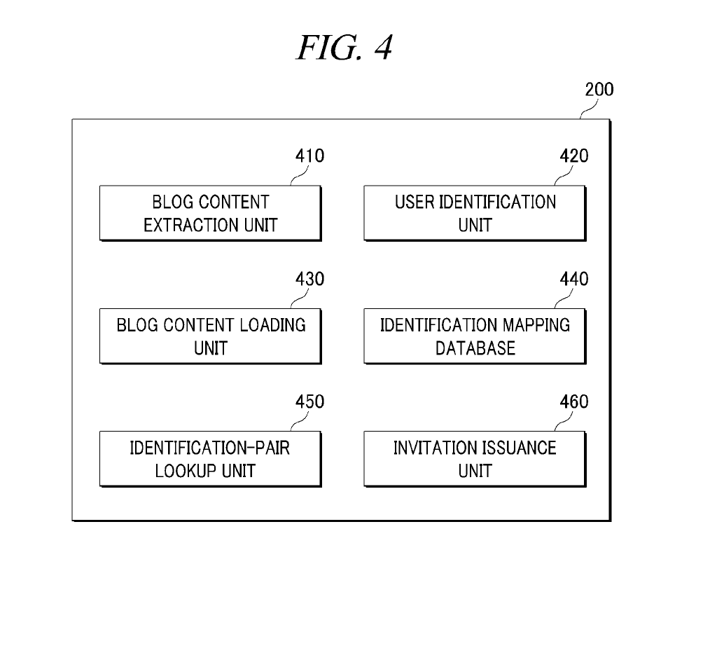

FIG. 4 shows a schematic block diagram illustrating an example architecture of a blog migration management system, arranged in accordance with at least some embodiments described herein.

As depicted, blog migration management system 200 may include a blog content extraction unit 410, a user identification unit 420, a blog content loading unit 430, an identification mapping database 440, an identification-pair lookup unit 450, and an invitation issuance unit 460. Although illustrated as discrete components, various components may be divided into additional components, combined into fewer components, or eliminated while being contemplated within the scope of the disclosed subject matter.

Blog content extraction unit 410 may be configured to extract blog content posted on a source blog (e.g., source blog 100). By way of example, but not limitation, the blog content may include at least one of a blog post (e.g., blog post 110), or a comment to the blog post (e.g., comment 120-1, 120-2, 120-3 or 120-4), an image file, a video file and an audio file.

User identification unit 420 may be configured to identify from the source blog an identification of a user who posted the blog content.

Blog content loading unit 430 may be configured to load the blog content extracted by blog content extraction unit 410 onto a destination blog (e.g., destination blog 140).

Identification mapping database 440 may be configured to store relationship between user identifications subscribed for the source blog and user identifications subscribed to the destination blog.

Identification-pair lookup unit 450 may be configured to determine whether identification mapping database 440 has stored thereon a pair of the user's identification for the source blog and the user's identification for the destination blog. In some embodiments, when identification-pair lookup unit 450 determines that identification mapping database 440 has stored thereon the pair of the user's identification for the source blog and the user's identification for the destination blog, identification-pair lookup unit 450 may retrieve from identification mapping database 440 the users identification for the destination blog. Then, blog content loading unit 430 may grant the user authority to edit and/or delete the blog content on the destination blog.

Invitation issuance unit 460 may be configured to issue an invitation for the user to subscribe to the destination blog and/or the identification mapping database, when identification-pair lookup unit 450 determines that identification mapping database 440 does not have stored thereon a pair of the users identification for the source blog and the user's identification for the destination blog.

In some embodiments, invitation issuance unit 460 may be further configured to send the issued invitation to the user via a communication means registered by the user for the source blog. By way of example, but not limitation, the communication means may include at least one of an electronic mail (e-mail) message, a short message service (SMS) message, a social network service (SNS) message, and a voice message.

In some embodiments, when the user responds to the invitation issued by invitation issuance unit 460, identification mapping database 440 may be updated to store a pair of the users identification for the source blog and the users identification for the destination blog, based at least in part on the user's response.

As such, blog migration management system 200 may allow any user other than a blog owner to edit and/or delete the migrated blog contents corresponding to the blog contents the user originally posted on the source blog.

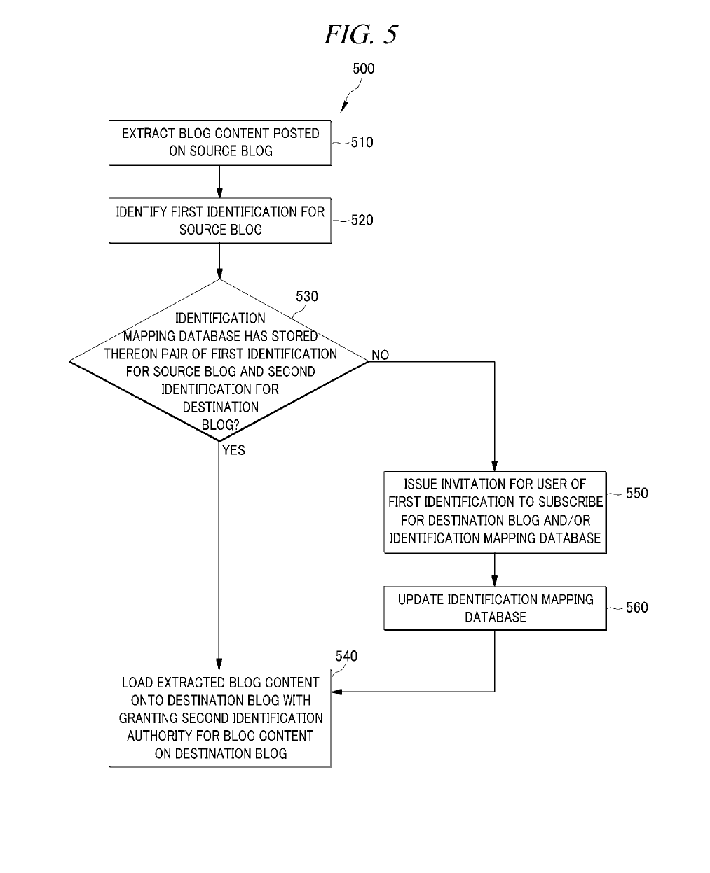

FIG. 5 shows an example flow diagram of a process for providing a blog migration management scheme, arranged in accordance with at least some embodiments described herein.

The process in FIG. 5 may be implemented in a blog migration management system such as blog migration management system 200 including blog content extraction unit 410, user identification unit 420, blog content loading unit 430, identification mapping database 440, identification-pair lookup unit 450, and invitation issuance unit 460, described above. An example process 500 may include one or more operations, actions, or functions as illustrated by one or more blocks 510, 520, 530, 540, 550 and/or 560. Although illustrated as discrete blocks, various blocks may be divided into additional blocks, combined into fewer blocks, or eliminated, depending on the desired implementation. Processing may begin at block 510.

At block 510 (Extract Blog Content Posted on Source Blog), blog migration management system 200 may extract blog content posted on a source blog (e.g., source blog 100). By way of example, but not limitation, the blog content may include at least one of a blog post (e.g., blog post 110), or a comment to the blog post (e.g., comment 120-1, 120-2, 120-3 or 120-4), an image file, a video file and an audio file. Processing may continue from block 510 to block 520.

At block 520 (Identify First Identification for Source Blog), blog migration management system 200 may identify from the source blog a first identification of a user, who posted the blog content on the source blog. Processing may continue from block 520 to decision block 530.

At decision block 530 (Identification Mapping Database Has Stored thereon Pair of First Identification for Source Blog and Second Identification for Destination Blog?), blog migration management system 200 may determine whether an identification mapping database has stored thereon a pair of the first identification for the source blog and a second identification for a destination blog (e.g., destination blog 140) associated with the first identification. When it is determined that the identification mapping database has stored thereon the pair of the first identification and the second identification, processing may continue from decision block 530 to block 540. Otherwise, processing may continue from decision block 530 to block 550.

At block 540 (Load Extracted Blog Content onto Destination Blog with Granting Second Identification Authority for Blog Content on Destination Blog), blog migration management system 200 may load the extracted blog content onto the destination blog with granting the second identification an authority for the blog content on the destination blog. By way of example, but not limitation, the authority for the blog content may include authority to edit and/or delete the blog content.

At block 550 (Issue Invitation for User of First Identification to Subscribe for Destination Blog and/or Identification Mapping Database), blog migration management system 200 may issue an invitation for the user of the first identification to subscribe for at least one of the destination blog and the identification mapping database. Then, blog migration management system 200 may send the invitation to the user of the first identification via a communication means registered by the user for the source blog, and receive a response from the user. Processing may continue from block 550 to block 560.

At block 560 (Update Identification Mapping Database), blog migration management system 200 may update the identification mapping database based at least in part on the response from the user. In some embodiments, when blog migration management system 200 receives from the user a request for subscribing to the identification mapping database and the second identification for the destination blog, blog migration management system 200 may update the identification mapping database to have further stored thereon a pair of the first identification and the received second identification. In some embodiments, when blog migration management system 200 receives from the user a request to subscribe to the destination blog and the identification mapping database, blog migration management system 200 may update the identification mapping database to have further stored thereon a pair of the first identification and the second identification created in accordance with the request. Processing may continue from block 560 to block 540.

One skilled in the art will appreciate that, for this and other processes and methods disclosed herein, the functions performed in the processes and methods may be implemented in differing order. Furthermore, the outlined steps and operations are only provided as examples, and some of the steps and operations may be optional, combined into fewer steps and operations, or expanded into additional steps and operations without detracting from the essence of the disclosed embodiments.

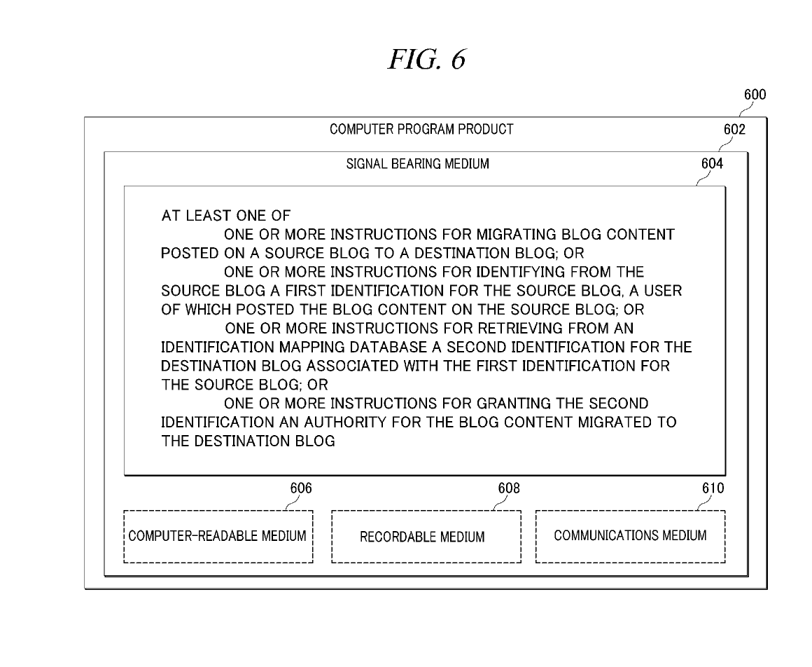

FIG. 6 illustrates example computer program products that may be utilized to provide a blog migration management scheme, arranged in accordance with at least some embodiments described herein.

Program product 600 may include a signal bearing medium 602. Signal bearing medium 602 may include one or more instructions 604 that, when executed by, for example, a processor, may provide the functionality described above with respect to FIGS. 1-5. By way of example, instructions 604 may include: one or more instructions for migrating blog content posted on a source blog to a destination blog; one or more instructions for identifying from the source blog a first identification for the source blog, a user of which posted the blog content on the source blog; one or more instructions for retrieving from an identification mapping database a second identification for the destination blog associated with the first identification for the source blog; or one or more instructions for granting the second identification an authority for the blog content migrated to the destination blog. Thus, for example, referring to FIG. 4, blog migration management system 200 may undertake one or more of the blocks shown in FIG. 5 in response to instructions 604.

In some implementations, signal bearing medium 602 may encompass a computer-readable medium 606, such as, but not limited to, a hard disk drive, a CD, a DVD, a digital tape, memory, etc. In some implementations, signal bearing medium 602 may encompass a recordable medium 608, such as, but not limited to, memory, read/write (R/W) CDs, R/W DVDs, etc. In some implementations, signal bearing medium 602 may encompass a communications medium 610, such as, but not limited to, a digital and/or an analog communication medium (e.g., a fiber optic cable, a waveguide, a wired communications link, a wireless communication link, etc.). Thus, for example, program product 600 may be conveyed to one or more modules of blog migration management system 200 by an RF signal bearing medium 602, where the signal bearing medium 602 is conveyed by a wireless communications medium 610 (e.g., a wireless communications medium conforming with the IEEE 802.11 standard).

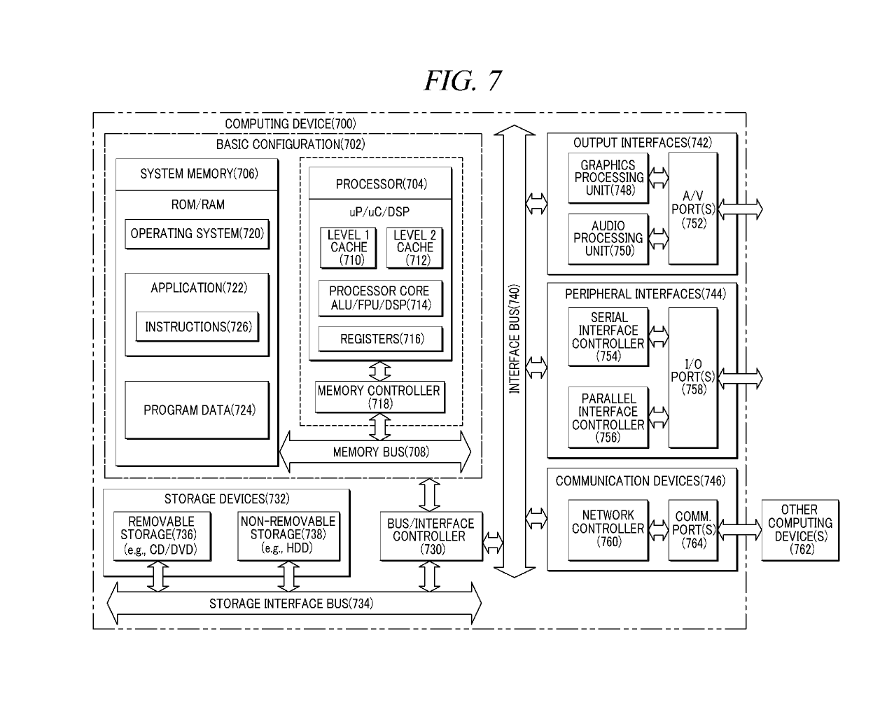

FIG. 7 is a block diagram illustrating an example computing device that may be utilized to provide a blog migration management scheme, arranged in accordance with at least some embodiments described herein.

In these examples, elements of computing device 700 may be arranged or configured for a server. In a very basic configuration 702, computing device 700 typically includes one or more processors 704 and a system memory 706. A memory bus 708 may be used for communicating between processor 704 and system memory 706.

Depending on the desired configuration, processor 704 may be of any type including but not limited to a microprocessor (μP), a microcontroller C), a digital signal processor (DSP), or any combination thereof. Processor 704 may include one more levels of caching, such as a level one cache 710 and a level two cache 712, a processor core 714, and registers 716. An example processor core 714 may include an arithmetic logic unit (ALU), a floating point unit (FPU), a digital signal processing core (DSP Core), or any combination thereof. An example memory controller 718 may also be used with processor 704, or in some implementations memory controller 718 may be an internal part of processor 704.

Depending on the desired configuration, system memory 706 may be of any type including but not limited to volatile memory (such as RAM), non-volatile memory (such as ROM, flash memory, etc.) or any combination thereof. System memory 706 may include an operating system 720, one or more applications 722, and program data 724. Application 722 may include instructions 726 that may be arranged to perform the functions as described herein including the actions described with respect to the blog migration management system 200 architecture as shown in FIG. 4 or including the actions described with respect to the flow charts shown in FIG. 5. In some examples, application 722 may be arranged to operate with program data 724 on an operating system 720 such that implementations for instructions for an electronic device as described herein.

Computing device 700 may have additional features or functionality, and additional interfaces to facilitate communications between basic configuration 702 and any required devices and interfaces. For example, a bus/interface controller 730 may be used to facilitate communications between basic configuration 702 and one or more data storage devices 732 via a storage interface bus 734. Data storage devices 732 may be removable storage devices 736, non-removable storage devices 738, or a combination thereof. Examples of removable storage and non-removable storage devices include magnetic disk devices such as flexible disk drives and hard-disk drives (HDD), optical disk drives such as compact disk (CD) drives or digital versatile disk (DVD) drives, solid state drives (SSD), and tape drives to name a few. Example computer storage media may include volatile and nonvolatile, removable and non-removable media implemented in any method or technology for storage of information, such as computer readable instructions, data structures, program modules, or other data.

System memory 706, removable storage devices 736 and non-removable storage devices 738 are examples of computer storage media. Computer storage media includes, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which may be used to store the desired information and which may be accessed by computing device 700. Any such computer storage media may be part of computing device 700.

Computing device 700 may also include an interface bus 740 for facilitating communication from various interface devices (e.g., output devices 742, peripheral interfaces 744, and communication devices 746) to basic configuration 702 via bus/interface controller 730. Example output devices 742 include a graphics processing unit 748 and an audio processing unit 750, which may be configured to communicate to various external devices such as a display or speakers via one or more A/V ports 752. Example peripheral interfaces 744 include a serial interface controller 754 or a parallel interface controller 756, which may be configured to communicate with external devices such as input devices (e.g., keyboard, mouse, pen, voice input device, touch input device, etc.) or other peripheral devices (e.g., printer, scanner, etc.) via one or more I/O ports 758. An example communication device 746 includes a network controller 760, which may be arranged to facilitate communications with one or more other computing devices 762 over a network communication link via one or more communication ports 764.

The network communication link may be one example of a communication media. Communication media may typically be embodied by computer readable instructions, data structures, program modules, or other data in a modulated data signal, such as a carrier wave or other transport mechanism, and may include any information delivery media. A “modulated data signal” may be a signal that has one or more of its characteristics set or changed in such a manner as to encode information in the signal. By way of example, and not limitation, communication media may include wired media such as a wired network or direct-wired connection, and wireless media such as acoustic, radio frequency (RF), microwave, infrared (IR) and other wireless media. The term computer readable media as used herein may include both storage media and communication media.

Computing device 700 may be implemented as a portion of a small-form factor portable (or mobile) electronic device such as a cell phone, a personal data assistant (PDA), a personal media player device, a wireless web-watch device, a personal headset device, an application specific device, or a hybrid device that include any of the above functions. Computing device 700 may also be implemented as a personal computer including both laptop computer and non-laptop computer configurations.

The present disclosure is not to be limited in terms of the particular embodiments described in this application, which are intended as illustrations of various aspects. Many modifications and variations can be made without departing from its spirit and scope, as will be apparent to those skilled in the art. Functionally equivalent methods and apparatuses within the scope of the disclosure, in addition to those enumerated herein, will be apparent to those skilled in the art from the foregoing descriptions. Such modifications and variations are intended to fall within the scope of the appended claims. The present disclosure is to be limited only by the terms of the appended claims, along with the full scope of equivalents to which such claims are entitled. It is to be understood that this disclosure is not limited to particular methods, reagents, compounds, compositions or biological systems, which can, of course, vary. It is also to be understood that the terminology used herein is for the purpose of describing particular embodiments only, and is not intended to be limiting.

With respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

It will be understood by those within the art that, in general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” etc.). It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to embodiments containing only one such recitation, even when the same claim includes the introductory phrases “one or more” or “at least one” and indefinite articles such as “a” or “an” (e.g., “a” and/or “an” should be interpreted to mean “at least one” or “one or more”); the same holds true for the use of definite articles used to introduce claim recitations. In addition, even if a specific number of an introduced claim recitation is explicitly recited, those skilled in the art will recognize that such recitation should be interpreted to mean at least the recited number (e.g., the bare recitation of “two recitations,” without other modifiers, means at least two recitations, or two or more recitations). Furthermore, in those instances where a convention analogous to “at least one of A, B, and C, etc.” is used, in general such a construction is intended in the sense one having skill in the art would understand the convention (e.g., “a system having at least one of A, B, and C” would include but not be limited to systems that have A alone, B alone, C alone, A and B together, A and C together, B and C together, and/or A, B, and C together, etc.). In those instances where a convention analogous to “at least one of A, B, or C, etc.” is used, in general such a construction is intended in the sense one having skill in the art would understand the convention (e.g., “a system having at least one of A, B, or C” would include but not be limited to systems that have A alone, B alone, C alone, A and B together, A and C together, B and C together, and/or A, B, and C together, etc.). It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.”

In addition, where features or aspects of the disclosure are described in terms of Markush groups, those skilled in the art will recognize that the disclosure is also thereby described in terms of any individual member or subgroup of members of the Markush group.

As will be understood by one skilled in the art, for any and all purposes, such as in terms of providing a written description, all ranges disclosed herein also encompass any and all possible subranges and combinations of subranges thereof. Any listed range can be easily recognized as sufficiently describing and enabling the same range being broken down into at least equal halves, thirds, quarters, fifths, tenths, etc. As a non-limiting example, each range discussed herein can be readily broken down into a lower third, middle third and upper third, etc. As will also be understood by one skilled in the art all language such as “up to,” “at least,” and the like include the number recited and refer to ranges which can be subsequently broken down into subranges as discussed above. Finally, as will be understood by one skilled in the art, a range includes each individual member. Thus, for example, a group having 1-3 cells refers to groups having 1, 2, or 3 cells. Similarly, a group having 1-5 cells refers to groups having 1, 2, 3, 4, or 5 cells, and so forth.

From the foregoing, it will be appreciated that various embodiments of the present disclosure have been described herein for purposes of illustration, and that various modifications may be made without departing from the scope and spirit of the present disclosure. Accordingly, the various embodiments disclosed herein are not intended to be limiting, with the true scope and spirit being indicated by the following claims.

What is claimed is:

1. A blog migration management system, comprising:
a blog content extraction unit configured to extract blog content posted on a source blog;
a user identification unit configured to identify from the source blog an identification of a user who posted the blog content; and
a blog content loading unit configured to load the blog content onto a destination blog, with granting the user an authority for the blog content on the destination blog.

2. The blog migration management system of claim 1, wherein the blog content includes at least one of a blog post, a comment to the blog post, an image file, a video file and an audio file.

3. The blog migration management system of claim 1, wherein the authority for the blog content includes at least one of an authority to edit the blog content and an authority to delete the blog content.

4. The blog migration management system of claim 1, further comprising:
an identification mapping database configured to store relationship between user identifications subscribed for the source blog and user identifications subscribed for the destination blog.

5. The blog migration management system of claim 4, wherein the blog content loading unit is further configured to grant the user the authority for the blog content on the destination blog, when the identification mapping database has stored thereon a pair of the user's identification for the source blog and the user's identification for the destination blog.

6. The blog migration management system of claim 4, further comprising:
an invitation issuance unit configured to issue an invitation for the user to subscribe for at least one of the destination blog and the identification mapping database, when the identification mapping database does not have stored thereon a pair of the users identification for the source blog and the user's identification for the destination blog.

7. The blog migration management system of claim 6, wherein the invitation issuance unit is further configured to send the issued invitation to the user via a communication means registered by the user for the source blog.

8. The blog migration management system of claim 7, wherein the communication means includes at least one of an electronic mail (e-mail) message, a short message service (SMS) message, a social network service (SNS) message, and a voice message.

9. The blog migration management system of claim 6, wherein the identification mapping database is further configured to store a pair of the user's identification for the source blog and the users identification for the destination blog based at least in part on the users response to the invitation issued by the invitation issuance unit.

10. A method performed under control of a blog migration management system, comprising:
extracting blog content posted on a source blog;
identifying from the source blog a first identification for the source blog, a user of which posted the blog content on the source blog;
determining whether an identification mapping database has stored thereon a pair of the first identification for the source blog and a second identification for a destination blog associated with the first identification; and
loading the extracted blog content onto the destination blog with granting the second identification an authority for the blog content on the destination blog, when the identification mapping database has stored thereon the pair of the first identification for the source blog and the second identification for the destination blog.

11. The method of claim 10, wherein the blog content includes at least one of a blog post, a comment to the blog post, an image file, a video file and an audio file.

12. The method of claim 10, wherein the authority for the blog content includes at least one of an authority to edit the blog content and an authority to delete the blog content.

13. The method of claim 10, further comprising:
issuing an invitation for the user of the first identification to subscribe for at least one of the destination blog and the identification mapping database, when the identification mapping database does not have stored thereon the pair of the first identification for the source blog and the second identification for the destination blog.

14. The method of claim 13, further comprising:
sending the invitation to the user of the first identification via a communication means registered by the user for the source blog.

15. The method of claim 14, wherein the communication means includes at least one of an electronic mail (e-mail) message, a short message service (SMS) message, a social network service (SNS) message, and a voice message.

16. The method of claim 13, further comprising:
receiving from the user a request for subscribing for the identification mapping database and the second identification for the destination blog; and
updating the identification mapping database to have further stored thereon a pair of the first identification and the received second identification.

17. The method of claim 13, further comprising:
receiving from the user a request for subscribing the destination blog and the identification mapping database; and
updating the identification mapping database to have further stored thereon a pair of the first identification and the second identification created in accordance with the request.

18. A computer-readable storage medium having stored thereon computer-executable instructions that, in response to execution, cause a blog migration management system to perform operations, comprising:
migrating blog content posted on a source blog to a destination blog;
identifying from the source blog a first identification for the source blog, a user of which posted the blog content on the source blog;
retrieving from an identification mapping database a second identification for the destination blog associated with the first identification for the source blog; and
granting the second identification an authority for the blog content migrated to the destination blog.

19. The computer-readable storage medium of claim 18, wherein the identification mapping database is configured to store relationship between user identifications subscribed for the source blog and user identifications subscribed for the destination blog.

20. The computer-readable storage medium of claim 18, wherein the blog content includes at least one of a blog post, a comment to the blog post, an image file, a video file and an audio file.

21. The computer-readable storage medium of claim 18, wherein the authority for the blog content includes at least one of an authority to edit the blog content and an authority to delete the blog content.

22. The computer-readable storage medium of claim 18, wherein the operations further comprise:
issuing an invitation for the user to subscribe for at least one of the destination blog and the identification mapping database, when failing to retrieve from the identification mapping database the second identification for the destination blog that is associated with the first identification for the source blog.
